(19) United States
(12) Patent Application Publication
(10) Pub. No.: US 2016/0019505 A1
(43) Pub. Date: Jan. 21, 2016

(54) COMBINING REAL-TIME LABOR MARKET DATA WITH CAREER INTEREST RECOMMENDATIONS FOR OPTIMAL CAREER SELECTION

(71) Applicant: Apollo Education Group, Inc., Phoenix, AZ (US)

(72) Inventors: Negin Kamangar, Los Altos, CA (US); Igor Khayet, San Francisco, CA (US); Chad Lane, Lafayette, CA (US); Rick Hubbard, Seattle, WA (US); Ryan Penner, Newcastle, WA (US); Lisa Roney, Seattle, WA (US); Mary Osadzinski, Long Beach, CA (US)

(21) Appl. No.: 14/332,264

(22) Filed: Jul. 15, 2014

(51) Int. Cl. G06Q 10/10

(52) U.S. Cl. CPC G06Q 10/1053

(57) ABSTRACT

Techniques for providing potential career paths based on a user's interests and incorporating real-time job market and educational information for that particular career path. A guidance service stores a plurality of jobs and their corresponding job-interest attributes. Then the guidance service obtains user-interest information from the user and automatically selects a plurality of jobs based on the user-interest information and the job-interest attribute values associated with the plurality of jobs. The guidance service then presents the user with the plurality of jobs and job market information and educational information associated with each of the plurality of jobs.

### BACKGROUND

When a person is looking to start a new career, they usually think about what they would like to do for the rest of their life. Many people are unsure of what type of career to pursue. Typically, people are looking to find a career doing something that they enjoy and that is naturally aligned with their own personal interests. Choosing a career is a complex process that involves understanding a person's interests and determining what jobs are best aligned with that person's interests.

Services to determine what interests the user possesses have been available for decades. These services typically ask a series of questions, and based on the user's answers, the service determines what general interest concepts in a career fit the user best. For instance, if the user enjoys talking to people and solving the problems of others, then the service may suggest becoming a psychiatrist.

However, many of these services leverage only career data from government or other public resources. These government and public resources are used to provide job market information. Job market information may include geo-location based hiring trends, job skill and education requirements, top employers, and salary ranges. Job market information published by government and public sites are typically published on an annual basis. By not publishing more frequently, the job market information from these government and public sites are likely to be inaccurate and out of date.

Another problem with relying and government and public job data is that the government methodology for naming jobs does not always coincide with actual job titles that employers use for job openings. By not having a clear connection between the job naming methodology and actual job openings, determining accurate job market information is difficult. Without having accurate job market information for each matched career a user may be misled into pursuing a career that is actually not in demand in his area or one that he is not adequately qualified to perform.

### BRIEF DESCRIPTION OF THE DRAWINGS

In the drawings of certain embodiments in which like reference numerals refer to corresponding parts throughout the figures:

FIG. 1 illustrates a flow diagram of the method for storing and comparing job-interest attribute values to user-interest values, and presenting the user with a subset of matching jobs and associated real-time job market and educational information.

FIG. 2 illustrates a flow diagram of the method by which jobs are their corresponding jobs-interest attributes values are stored, mapped, and compared to the user-interest values.

FIG. 3 illustrates a flow diagram of the method by which user-interest information is received, normalized, mapped, and compared to a set of jobs and their corresponding job-interest attribute values.

FIG. 4 illustrates an embodiment of the user selection screen highlighting different types of users.

FIG. 5 illustrates embodiments of job family table hierarchies.

FIG. 6 illustrates an embodiment of a matching job and its associated real-time job market information.

FIG. 7 illustrates an embodiment of presenting the user with a job family match and aggregated job market information.

FIG. 8 illustrates a flow diagram of mapping job market information to static job titles and matching job codes for the purposes of displaying matching jobs with associated job market information.

FIG. 9 illustrates an example computer system that may be specially configured to perform various techniques described herein.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Methods, stored instructions, and machines are provided herein for a user to choose a career in an intelligent manner. One or more computing devices, such as one or more career guidance servers, operate a career guidance service that recommends potential jobs to the user that are closely aligned with the user's interests, and associates the job recommendations with real-time labor market information for each job presented. The career guidance service may be a centralized service that collects, receives, or otherwise accesses information relevant to the user's interests and information relevant to possible job matches. This information is aggregated, analyzed, and used to compile a set of matching jobs that align closest with the user's own interests.

The guidance service is geared towards mapping career categories and their respective jobs to specified interest metrics. The guidance service stores a plurality of jobs for various careers and their corresponding job interest attributes. These job interest attributes are used to determine whether a user's interests align with a particular career. When a user completes a user interest assessment, the guidance service aligns the best possible careers to the user's interest assessment. Once a set of careers best matching the user's interests is identified, then real-time job market information is correlated with the respective careers, including information regarding the level of education required and potential degree programs available to qualify for those careers.

Providing real-time job market information along with the matched careers is particularly advantageous for the user because it gives the user the insight about the marketplace for that particular career and whether it is worth pursuing. For instance, a user may reside in Wyoming and may be interested in working in the criminal and investigation field. However, the job-market information for criminal and investigation jobs in Wyoming may indicate that there is very little demand from employers for criminal and investigative work within the past twelve months. The user may realize that embarking upon a career in the criminal and investigative field will likely not lead to promising job prospects. Knowing this the user may likely not pursue this type of career. The user may then look into other careers that may match his interests. For instance, if that same user's interests were matched to bookkeeping type jobs, and those bookkeeping jobs were in high demand in Wyoming, then the user would have confidence that pursuing a bookkeeping career would lead to a job. Once selecting a potential career path the user would then able to use the job-market and educational information to map out a path to fulfilling that particular career.

### Different Types of Users

In one embodiment, the guidance service is geared towards providing career guidance to many different types of users. A user could refer to a currently enrolled student, a prospective student, or a student that has graduated and is looking to find a matching career for his education and interests. Users may be further categorized into the following: 1) the user who is looking to start a new career; 2) the user who has an existing career and is looking to change careers; 3) the user who has an existing career and is looking to advance in his career; 4) and a user coming from the military looking to apply his skills from the military to a specific career.

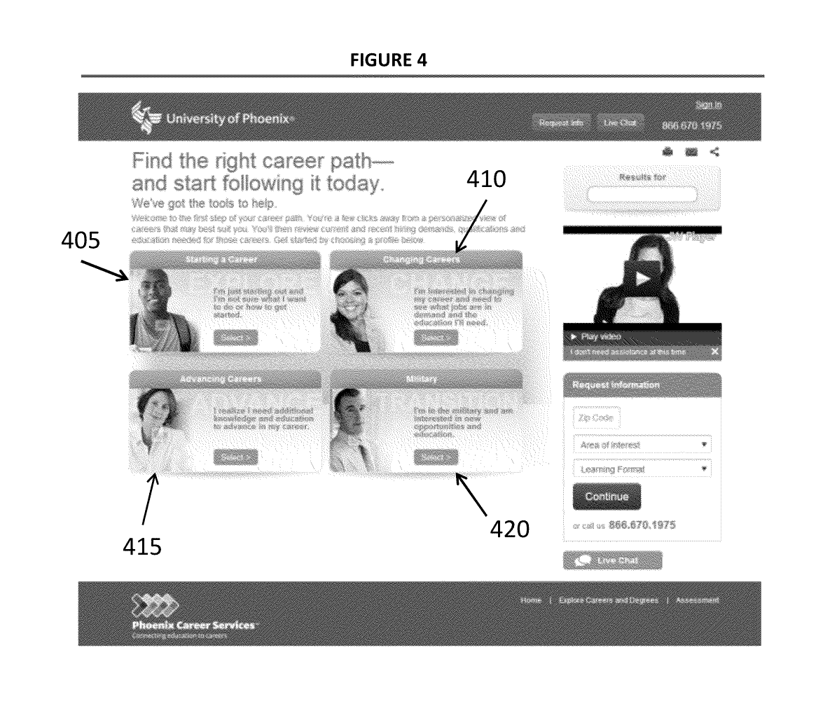

FIG. 4 is a depiction of an embodiment of the user selection screen. The category of users entitled “starting a new career” 405 includes users who are unsure of the type of career they are looking to embark upon. For these types of users, the guidance service may be configured to administer the user-interest assessment to assess the user's interests and determine specific careers that align with the user's specific interests. For instance, if the user's user-interest assessment concludes that the user has a strong interest in working with people, working outside, working in an office environment, or work involving being creative. Then based on these interests, the guidance service will determine the best possible matches for the user.

The category of users entitled “changing careers” 410 may include users that are currently working in one field and are looking to change career to another field. In this case, the user may or may not know what second career they plan to embark upon. If the user is unsure of what new career to embark upon, then the guidance service could administer the user-interest assessment. Once completed, the guidance service would determine the best matching careers to the user's interests. One embodiment of the “changing careers” category may take into account the user's interests along with their current skill-set from their current career to determine the best possible career matches that are aligned to the user's interests and skill-sets.

The category entitled “advancing careers” 415 may include users looking to advance to a job in their current field. In one embodiment, the guidance service would be configured to filter out careers not related to the user's current career. For instance, if the user is a software developer then the system would filter all careers having no relation to the field of software development. However, careers related to software development such as, management, quality assurance, hardware/software management may be included and used to determine the best career advancement for the user.

The category entitled “military” 420 may include users who had prior military service and are looking for careers related and aligned with their past military experience. In one embodiment, the guidance service may incorporate the user's interests along with any military experience the user possesses to adjust their user-interest values accordingly.

Other embodiments may include other user categories, not listed above.

### Job

A career is referred to herein as a job, where a job is a specific career defined by its occupation or profession. A job opening is a specific employment position made available by a specific employer. In one embodiment attributes associated with a job may include, but is not limited to, job-interests, job-market attributes, and job-description attributes.

### Job-Interest Attributes

A job-interest attribute may refer to one of many types of interests associated with that specific job. An “interest” is a type of activity that a user likes to do. Certain types of activities may be associated with certain types of jobs. In one embodiment, the job-interest attributes may include, but are not limited to, the following: enterprising, investigative, conventional, social, artistic, and realistic.

The enterprising interest value may reflect the level in which the specific job involves frequently starting up and carrying out projects.

The investigative interest value may reflect the level in which a specific job involves working with ideas, and requires an extensive amount of thinking, such as searching for facts and figuring out problems mentally.

The conventional interest value may reflect the level in which a specific job involves frequently following a set of procedures and routines.

The social interest value may reflect the level in which a specific job involves working with, communicating with, teaching people, helping or providing service to others.

The artistic interest value may reflect the level in which a specific job involves working with forms, designs and patterns and may require expression without following a clear set of rules.

The realistic interest value may reflect the level in which a specific job involves working on activities that include practical, hands-on problems and solutions, commonly dealing with plants, animals, and real-wood materials like wood, tools, and machinery.

Values for the set of job-interest attributes may be pre-calculated for each job and stored by the guidance service so that they can be compared to potential user-interest values. In one embodiment job-interest attribute values are determined by either the government classifications or provided by a third party. The Standard Occupational Classifications (SOC), provided by the Department of Labor, is a universal occupational classification system designed to allow both government agencies and private entities to produce comparable data. The SOC classifies jobs at four levels of aggregation which include: Major groups, Minor groups, Broad Occupation groups, and Detailed Occupation groups (SOC codes group). The SOC Major group is the top level group that lists jobs based on their field of practice. For example, the list may include Management Type occupations, Business and Financial occupations, Computer and Mathematical occupations, Architecture and Engineering occupations, and Legal occupations. Within each Major group, there are one or more minor groups. For instance, within the Computer and Mathematical occupations Major group, there are two Minor groups, the Computer occupations group and the Mathematics occupation group. Within each minor group there is a set containing one or more Broad Occupation groups. The Broad Occupation groups for the Computers Minor group may include the following categories: Computer and Information research scientists, computer information analysts, software developers and programmers, database and systems administrators, and computer support specialists. Within these Broad Occupation groups there are listings for the SOC codes group. The SOC codes group contains a more specific categorization of different types of jobs within each Broad Occupation category. For instance, for the Software Developers and Programmers Broad Occupation group, the SOC group may consist of: Computer Programmers, Application Developers, System Software Developers, and Web Developers.

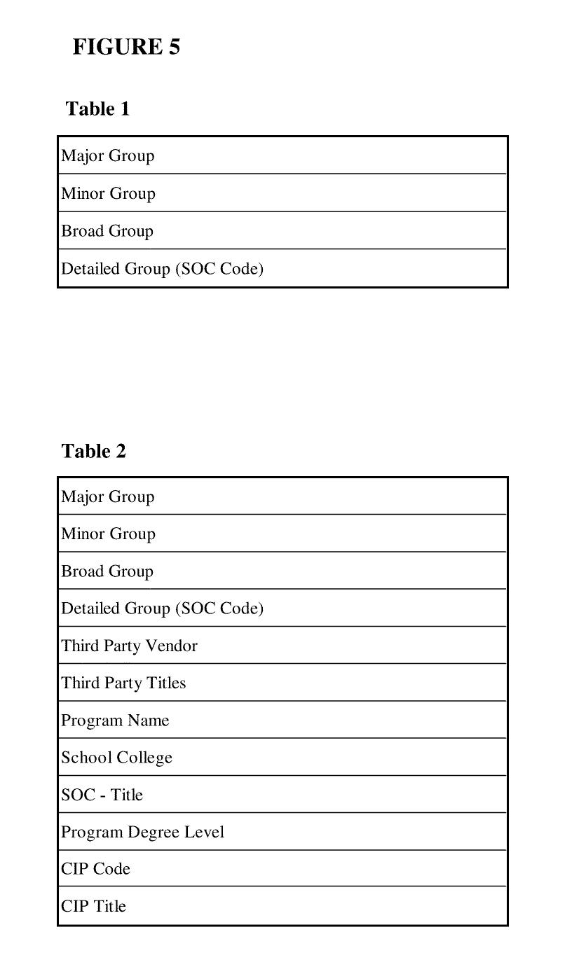

Table 1 in FIG. 5 displays an embodiment of the SOC methodology showing the four levels of hierarchy with the broadest group, the Major Group, as the top group. In one embodiment the job-interest attribute values are mapped to the SOC codes. By doing so the Guidance service is able to aggregate matching jobs into larger categories represented by Broad, Minor and Major group. This is advantageous when a user aligns with several Minor groups because instead of displaying the matches in a list format based on the SOC Code groups, the jobs can be grouped together for a better understanding of what fields may be suited for the user. Other embodiments may use different classification systems but would still maintain levels of hierarchy for aggregation purposes.

### Job Market Information

Job-market information refers to particular attributes associated with the job. This includes real-time job market information. In one embodiment, the job-market information includes the following: current market demand, salary range, education requirements and available degree programs, skills requirements, experience requirements, and employers associated with that type of job. The job-market attributes may be customized to reflect attributes specific to the particular geo-location of the user. For instance, the job-market attributes may be customized to only reflect information about current employers within the user's specific geo-location.

In one embodiment, “current market demand” is the level of demand for a particular job within a specific geo-location. The demand for a job may be measured by the number of job openings currently listed by employers for that type of job. Other embodiments may measure market demand as the number of job openings in a particular area versus the total number of job openings for all types of jobs. Other embodiments may measure the ratio of job openings for that type of job in the particular geo-location versus the number of job openings for that job over the whole country. If that particular geo-location has a high number of job openings when compared to other parts of the country the guidance service may label that job as being in high demand for that geo-location. Salary range may similarly be measured by the different salaries offered by different employers for that particular job within the user's specific geo-location. Current job openings offered by employers may be used to compile a list of top employers for that particular type of job.

Skills for a particular job are referred to herein as job-skills This may include technical skills related to performing the tasks associated with the particular job. For instance, a database administrator job may require skills such as basic table manipulation, normalization techniques, understanding ACID, and database security. Identifying these particular skills helps the user understand what is required to perform the job. Another embodiment of job-skills may assign values to each skill so that each skill could be evaluated based on the level of skill that job requires. In the previous example, the database administrator job may require an expert level of skills for basic table manipulation but only require a minimal level of skills in normalization. With measureable job-skill values a user can accurately determine whether they are currently qualified for the specific job based on the skills possessed by the user. Similarly, job-experience requirements can be determined by job openings posted by employers.

### Educational Information

Educational requirements may be determined by the current job opening descriptions. Using the education requirements in job openings, the guidance service can map educational programs and courses that can help achieve the required educational requirement. This information is particularly advantageous to a user because it can give the user an educational roadmap on what programs and degrees will lead to qualifying for that particular job.

In one embodiment, common degree programs from various colleges are correlated to the educational degree requirements in the job openings. For instance, if a job opening requires an applicant to possess a B.S. in Computer Science or equivalent then common degree programs correlated to this requirement could include Computer Science degrees from various colleges. Another embodiment could further correlate other degrees and programs such as Computer Engineering or Computer Science certification programs to the specific job opening. These embodiments of common degree programs may be preapproved and preselected by Deans of the participating educational institutions. The common degree programs may include the set of courses required for completing those degree programs. By correlating educational details for each job, the user is given a roadmap of what courses and degrees need to be pursued to qualify for that particular job.

### Job Title Descriptions

In order to utilize the job market information for each job opening the job-description attributes must be mapped to each particular job. Job-description attributes refer to specific titles and descriptions used to describe the job openings in the user's geo-location. For instance, job openings for a Database Administrator may include: Oracle Database Administrator, MySQL DBA, and Database Developer. All of these job openings may be mapped to one “Database Administrator” job. By mapping all of these job openings to one job, the user will be able to get a more accurate compilation of the job market information associated with all of the listed job openings. However, current SOC titles associated with the SOC codes are not always reflective of the current job opening titles because there are not updated on a real-time basis and therefore the mapping of job-description attributes and associated job market information will be inaccurate and not beneficial to the user.

In one embodiment, static job titles that are more reflective of the current job openings are used to map titles and descriptions. These static job titles may originate from third party vendors, whereby the third party vendor static job titles are updated more frequently than the SOC codes. The third party static job titles are also mapped to the SOC code hierarchy in order to utilize the job-interest value mapping to the SOC codes. By having this dual mapping between the SOC codes, the third party static job titles, and the job-description attributes of the current job openings the guidance system is able to present the user with not only SOC codes for jobs best matching the user's interests, but also job-market information that is aggregated from job openings within the user's specific geo-location for each job.

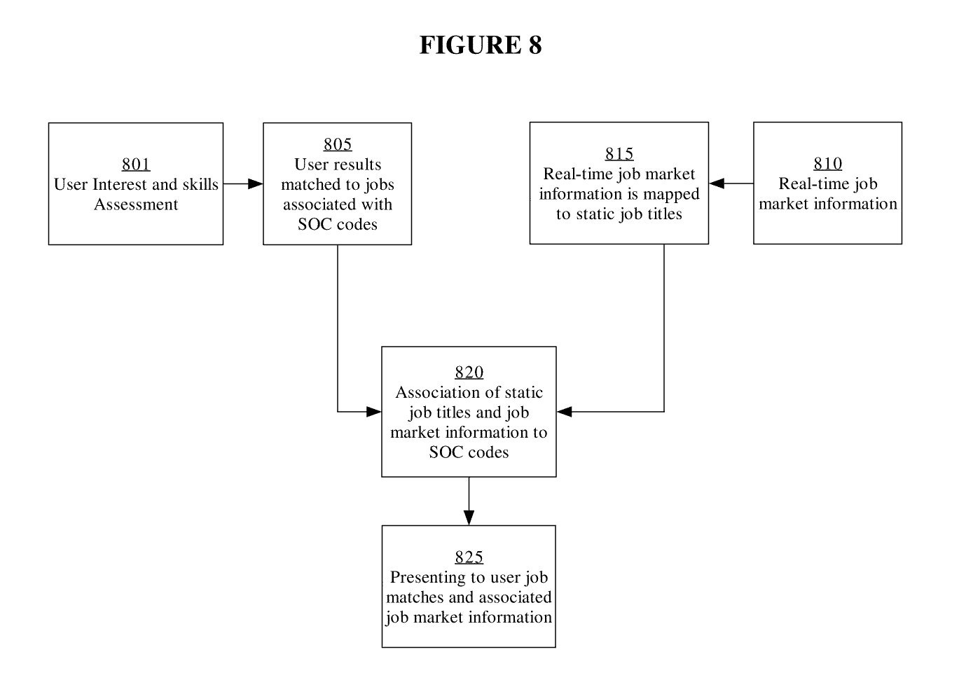

FIG. 8 is a depiction of using third party vendor static titles to map the job-market information to the SOC codes. At step 801, the guidance service receives the user-interest and skills assessment information. At step 805, the guidance service matches the user-interests to the pre-calculated job-interests associated with the jobs at the SOC code level. The SOC code level may refer to jobs provided by either the government SOC hierarchy or third party vendor hierarchy. At step 810, real-time job-market information is gathered for the purpose of associating it with third party static job titles. At step 815, the real-time job market information is mapped to third party static job titles. At step 820, the third party static job titles are associated with the corresponding SOC codes that match the user's interests. At step 825, the guidance service presents the user with the matching jobs using the SOC codes and the associated the third party static job titles order to present all relevant real-time job-market information.

FIG. 5, Table 2 is a depiction of the mapping between the SOC hierarchy, the third party static job titles, and the job-market information. Table 2 shows the SOC taxonomy at the top using Major Group, Minor Group and SOC codes. The third party static title information and college degree/course information are located in smaller subsets below depicted by the following rows: third party vendor, third party vendor job title, program name, college name, SOC Title, program degree level, CIP code, and CIP title. The CIP code and CIP Title refer to instructional programs within a particular college program. By using this hierarchy, the guidance service is able to aggregate job opening and education specific data to each SOC code and their corresponding Minor and Major groups.

### Presentation of Job Information

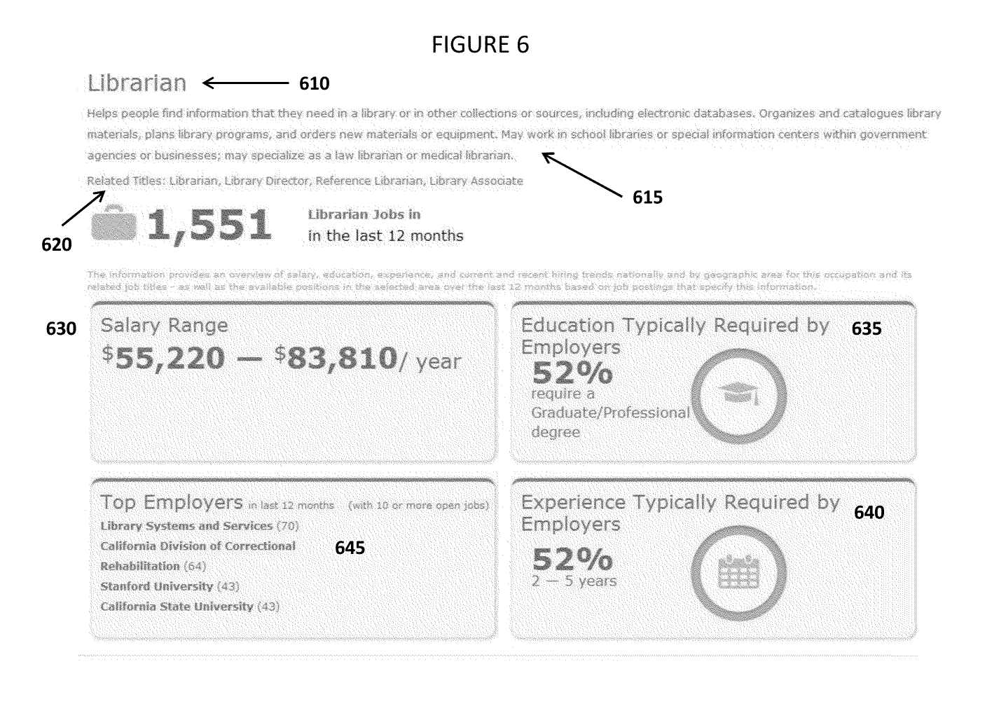

In one embodiment of the guidance service, the set of one or more best matched jobs is presented to the user in a format where the job-market information and job-descriptions for each job opening are aggregated for each matched job. FIG. 6 shows one embodiment for displaying the aggregated information. In FIG. 6, job title 610 refers to the third party static title for the particular job. The job-description 615 is a description associated with the particular job, in this case a librarian. In one embodiment the job-description may originate from related job openings, while another embodiment may pre-assign a job-description that is directly related to the specific job title itself. The Related titles 620 refer to other job titles given by employers advertising the librarian job. This is particularly informative to the user because it exposes the user to the different types of titles given to a job by various employers. The job salary range 630, is an aggregation of all salaries offered from the related job openings. This gives the user an idea of the salary range for a particular job. Education 635 refers to the required education for a particular job. In this case, the education requirement is an aggregation calculated from the related job openings. By aggregating the job opening educational requirements, the user can get a general sense of how much education is typically required for that particular job. Experience required 640 refers to the aggregated experience required from the job openings. Top employers 645 refers to the employers for that particular job.

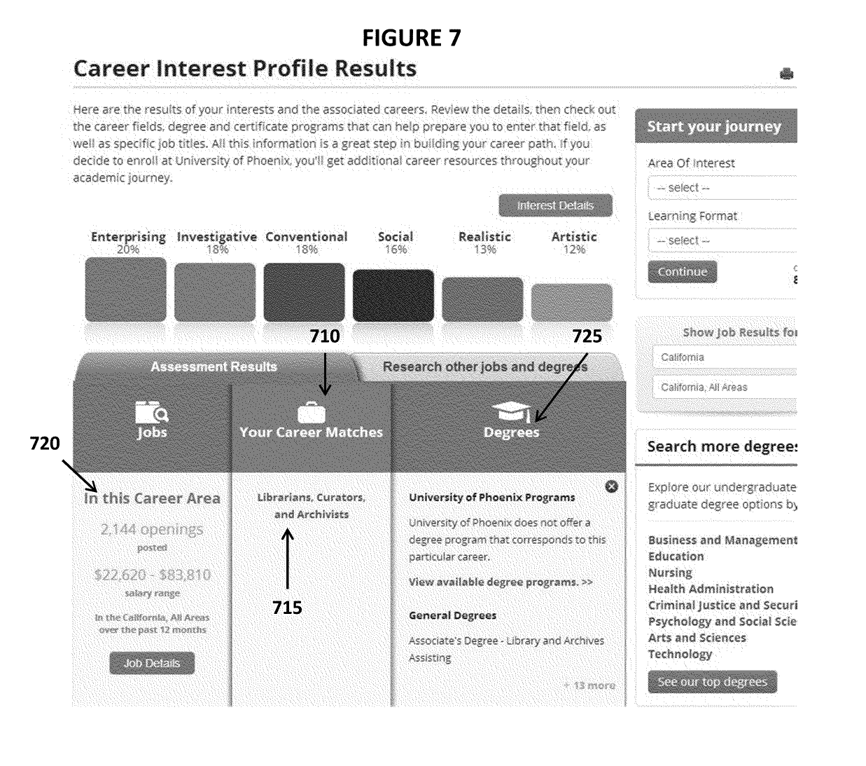

The guidance service may also further aggregate the matched jobs into their respective Major, Minor, or Broad Groups. In one embodiment, FIG. 7 is a top level aggregation where the user is presented with job matches by each Minor Group. The Minor Groups 710 are provided in the “Your Career Matches” column. The Librarians, Curators, and Archivists Group 715 is the Minor Group level. It shows the statistics for the various jobs in the user's geo-location for that particular Minor group. The “In this Career Area” section 720 shows job-market information aggregated all the way up to the Minor Group level. In this embodiment, the total number of job openings within this Minor Group is displayed along with the aggregated salary range information. Other embodiments may show other aggregated information job-market and job opening information. The Degrees column 725 displays an aggregation of the educational degree programs required for all jobs within this Minor Group.

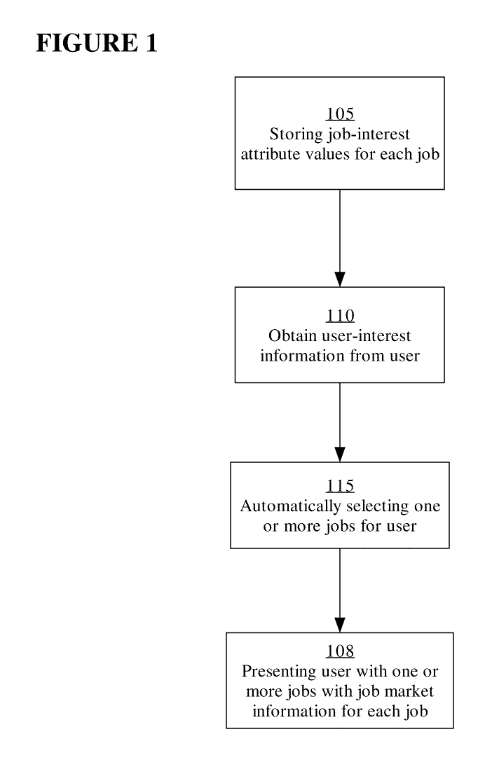

FIG. 1 is a flow diagram that depicts the overall process by which the guidance service stores jobs and their corresponding job-interest attribute values, receives user-interest values, selects a plurality of jobs matching jobs for the user, and presents the subset of matching jobs along with the job market information. At step 105, the guidance server stores a plurality of jobs and their corresponding job-interest attributes. At step 110, the guidance service obtains user-interest information from the user. At step 115, the guidance server automatically selects a plurality of jobs based on the user-interest information and the job-interest attribute values associated with the plurality of jobs. At step 120, the guidance service presents the user with the plurality of jobs and job market information and educational information associated with each of the plurality of jobs.

### Sorting Best Job Matches

The guidance service may sort the presented matching jobs according one or more job related attributes and job categories. In one embodiment, the guidance service may sort the matched jobs based on how well they align with the user-interests. This sorting method is particularly advantageous because the user would be presented with the best matching job first. This type of sorting would also apply to Minor Group displays, where the level of aligned interest for each job within a Minor Group is averaged. Then the highest average level of interest is presented to the user first.

Other embodiments of sorting the job matches may include sorting the job matches based on the user's skills or preferences. For instance, if the user expresses a preference to see all jobs with the highest salary range first then the guidance service would be able to sort by the salary range. Another example is if the user wishes to see all jobs where he has already satisfied the education requirements, then the guidance service may sort the jobs based on whether the user information satisfies the education requirements associated with that particular job. The criteria for sorting jobs and job groups may include, but is not limited to, any of the job-market information attributes and job-interest attributes.

### Data Filtering

In one embodiment, the guidance service may be configured to filter out certain jobs based on the job market information attributes. One type of data filtering may be based on the user's preferences. For instance, user preference data filtering may encompass filtering out jobs before the guidance service determines best matches for the user. In this case, if the user specifies that he is only interested in jobs meeting the criteria of a salary range of $150,000 and above, then the guidance service would only determine best matches based on a subset of jobs consisting of only jobs that are $150,000 and above. Other filtering criteria may include, but not limited to, the type of user. If the user was an advancing career user, then the guidance service may filter out all jobs not related to the user's current field before determining best matches.

Another embodiment of filtering may be based on filtering jobs after determining best matches for the user. This type of post-filtering of the matched jobs subset would be beneficial to the user if the user later decides to filter the matched jobs after viewing the total set of matched jobs. An example of this would be when the guidance service returns the matched jobs to the user and then the user decides based on the matched jobs that he only wants to view a matched jobs that have a high market demand. In this case the post-filtering would be beneficial to the user because he will be able to view different filtered subsets of matched jobs without having to wait for the guidance service re-compute the matched results.

Filtering is not limited to filtering based on job market information. In one embodiment, the subset of jobs may be filtered based on the user's skill-set. For instance, if the user has particular computer programming skills, then the guidance service may filter out all jobs not related to computer programming. By doing so the user would be matched to jobs that not only align with his interests but also utilize his existing skills

### Mapping Jobs

In order to match the user's personal interests to a particular job, each job and its set of corresponding job-interest attribute values must be mapped to a position in n-dimensional space. As previously stated, embodiments of job-interest attribute values may either be pre-calculated or provided by a third party. Once each job is mapped to a job-specific position in n-dimensional space each job can then be evaluated against the set of user-interest values from the user. In one embodiment, the job-interest attribute values are used to calculate a length of the line, L. Then the line is normalized to a length of one. The attributes in this embodiment are as follows:
v_r=Realistic interest value
v_a=Artistic interest value
v_i=Investigative interest value
v_e=Enterprise interest value
v_c=Conventional interest value
v_s=Social interest value

The line, L is calculated by taking the square root of the sum of the squares of all the attributes:

(v_{—}r̂2+v_{—}â2+v_{—}î2+v_{—}ê2+v_{—}ĉ2+v_{—}ŝ2)̂0.5=L

Next, job-interest attribute results are calculated relative to each other by dividing each job-interest attribute value by the total length of the line, L. Each job-interest attribute result now corresponds to a dimension in the n-dimensional space.

Aj=v_{—}r/L

Bj=v_{—}a/L

Cj=v_{—}i/L

Xj=v_{—}i/L

Yj=v_{—}c/L

Zj=v_{—}s/L

Using the job-interest attribute results, coordinates for the particular job associated with the job-interest attribute values can be calculated as a point on a ⅛^{th} sphere with a radius of 1. The following equation is a representation of the calculated coordinates.

Aĵ2+Bĵ2+Cĵ2+Xŷ2+Zĵ2=1̂2

In the current embodiment the job-interest attribute results are stored as a baseline for an exact interest match for that particular job. The baseline results for each job will then be compared to user-interest results in order to determine whether this particular job best aligns with the user's interests.

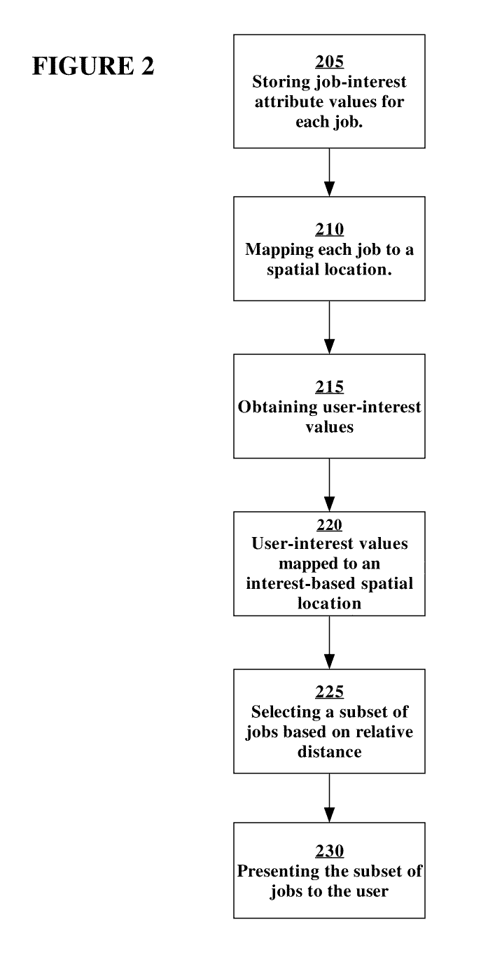

FIG. 2 is a flow diagram that depicts the process by which jobs and their respective job-interest attribute values are stored, mapped, and compared to the user-interest values. At step 205, job-interest attribute values are stored for each job. At step 210, each job is mapped to a job-specific spatial location in an n-dimensional space based on the job-interest attribute values. At step 215, the user-interest values are obtained from the user. Embodiments for obtaining the user-interest values include, but are not limited to, prompting the user with a series of questions to understand what interests the user. At step 220, the user-interest values are mapped to a user interest-based spatial location. At step 225, a subset of jobs is selected based on relative distance between the user interest-based spatial location and the job-specific spatial locations of the jobs. At step 230, the subset of selected jobs is presented to the user.

### Determining User-Interest Results

In order to determine which jobs closely align with the user's interests, the guidance service must evaluate the user's interest level by incorporating all user-interest values into one measurement. In one embodiment the guidance service prompts the user with a series of questions. Based on the user's answers, the guidance service is able to assign values for each of the measured user-interest values. The measured user-interest values are a set of interests that correspond to the same interests previously stored for each job. For example, the measured user-interest values would include the following interests: enterprising, investigative, conventional, social, artistic, and realistic.

Once the user's answers are collected the user-interest values are calculated. Then the user-interest values are used to map the user interest to a user interest-based spatial location in n-dimensional space. This is done by first using the user-interest values to calculate the length of a line, L. Then the line is normalized to a length of one. The user-interest values are labelled as follows:
lv_r=Realistic interest value
lv_a=Artistic interest value
lv_i=Investigative interest value
lv_e=Enterprise interest value
lv_c=Conventional interest value
lv_s=Social interest value

Using the user-interest values, the length of the line “L” is calculated using the following equation:

(lv_{—}r̂2+lv_{—}â2+lv_{—}î2 +lv_{—}ê2+lv_{—}ĉ2+lv_{—}ŝ2)̂0.5=L

Next user-interest results are calculated relative to each other by dividing each user-interest value by the total length of the line, L. Each user-interest result now corresponds to a dimension in the n-dimensional space.

As=lv_{—}r/L

Bs=lv_{—}a/L

Cs=lv_{—}i/L

Xs=lv_i/L

Ys=lv_{—}c/L

Zs=lv_{—}s/L

Using the user-interest results, a coordinate for the user-interest can be calculated as a point on a ⅛^{th} sphere with a radius of 1. The following equation is a representation of the calculated coordinates.

Aŝ2+Bŝ2+Cŝ2+Xŝ2+Yŝ2+Zŝ2=1̂2

### Supplementing User-Interest Results

Other embodiments may include but are not limited to supplementing user-interest results by inputting information regarding the user's experience, skills, and/or education. Based on this extra information the guidance service may adjust user-interest values to account for the user's experience, skills, and/or prior education. By doing so, the guidance service is able to align the user's interests more accurately. For example, if the user inputted that he had extensive experience in creating mobile applications, then the guidance service may adjust his interests to reflect a strong interest in problem-solving and project design.

In another embodiment, if the user is currently enrolled in college, then the guidance service may access the user's transcripts to determine whether the user possesses certain skills based on the number of classes taken and the grades received.

Other embodiments may include administering a live skills assessment test to the user. Once the guidance service receives the user's answers to the skills assessment test, the guidance service could increase or decrease the user-interest values based on how well the user performed. For example, if the user has a particular interest in problem solving but, performed poorly on the problem solving portion of the skills assessment test, then the user's problem solving interest values may be lowered.

### Determining Bets Job Matches

In order to determine which jobs are best matched with the user's interest, the guidance service performs a distance calculation between the user interest-based spatial location previously calculated and the job-specific spatial location for each job. The closer the distance between the two points the more probable the match. In one embodiment, the distance between the user-interest spatial location and the job specific spatial location is referred to herein as the User Interest Level. A lower User Interest Level for a particular job means that the particular job is a better match for the user. The User Interest Level is then calculated for each job. The User Interest Level is calculated as the square root of the sum of the squares of the difference between each user-interest value and the corresponding job-interest attribute value. This is illustrated in the following equation:

User Interest Level=((As−Aj)̂2+(Bs−Bj)̂2+(Cs−Cj)̂2+(Xs−Xj)̂2+(Ys−Yj)̂2+(Zs−Zj)̂2)̂0.5

The “best match” would be if user-interest spatial location and the job-specific spatial location represented the same coordinates then the calculated User Interest Level would be zero. In one embodiment, the User Interest Level values are calculated for each job and the top matches are then displayed to the user.

In another embodiment after the User Interest Level is calculated for each job, the matched jobs are then grouped according to the job's Minor group or another SOC group and are labelled as a job family. After the job families are compiled, the average User Interest Level for each job family is calculated. Then the job families are sorted based on the average User Interest Level and the associated job market information is matched to each job and its respective job family. Top job family matches are then presented to the user. Top job family matches may be configured to display the top 3, top 5, or another predefined number of job family matches.

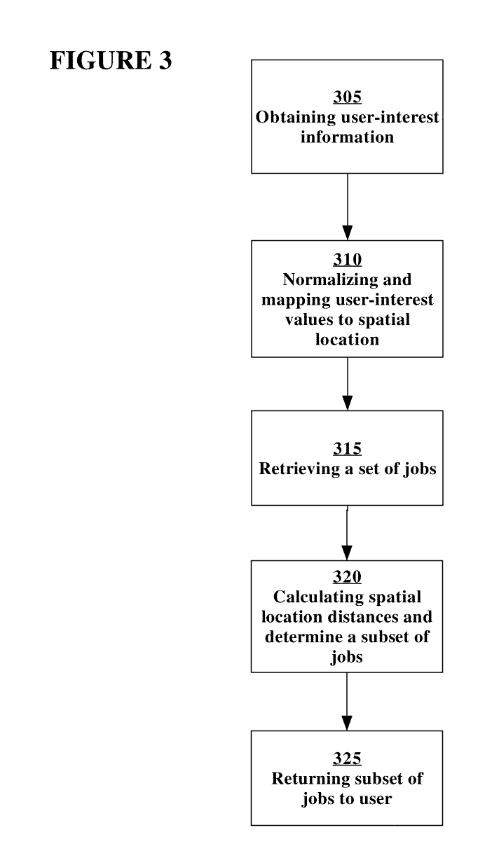

FIG. 3 is a flow diagram that depicts the process by which user-interest information is collected, normalized and mapped to a user-interest spatial location, compared to the spatial location of the job-specific spatial location for each job, and then a subset of jobs is returned to the user. At step 305, the guidance service obtains user-interest information from the user. One embodiment may be through a series of answers to questions presented to the user. In another embodiment, the user would input information to the guidance service interface. At step 310, the user-interest values are normalized to a length of one and then are mapped to a spatial location. At step 315, a set of jobs are retrieved to be compared to the user-interest spatial location. At step 320, the guidance service calculates the distance between the user-interest spatial location and the job specific spatial locations and determines a subset of jobs that have values indicating best matches. At step 325, the determined subset of jobs is returned to the user.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

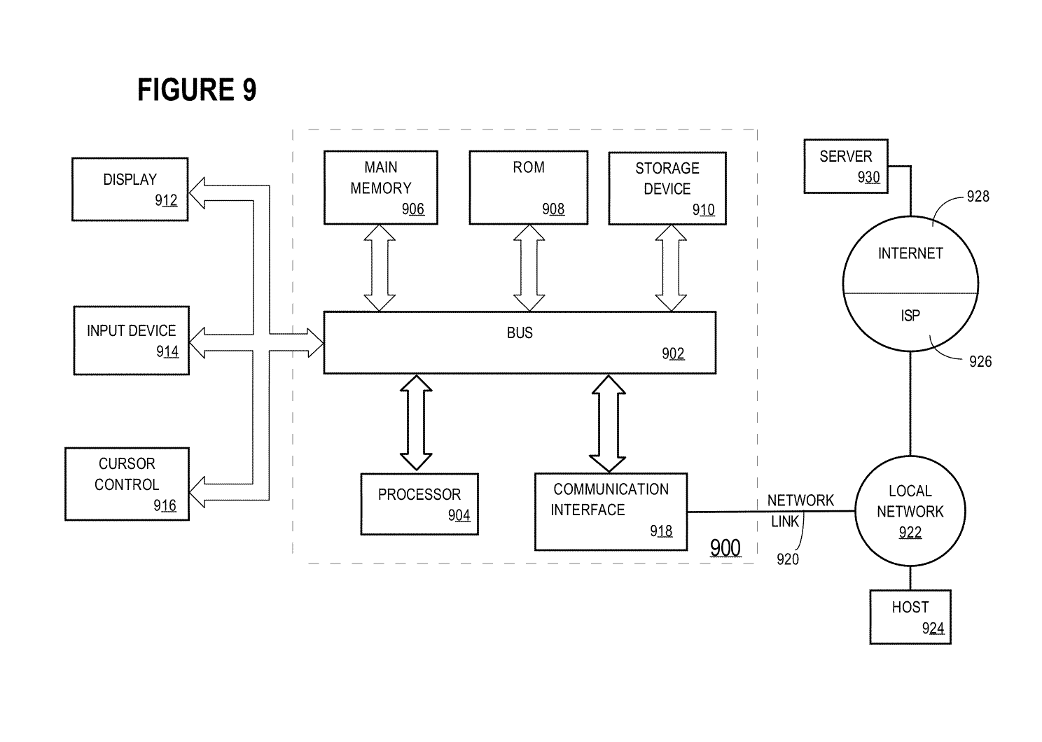

For example, FIG. 9 is a block diagram that illustrates a computer system 900 upon which an embodiment of the invention may be implemented. Computer system 900 includes a bus 902 or other communication mechanism for communicating information, and a hardware processor 904 coupled with bus 902 for processing information. Hardware processor 904 may be, for example, a general purpose microprocessor.

Computer system 900 also includes a main memory 906, such as a random access memory (RAM) or other dynamic storage device, coupled to bus 902 for storing information and instructions to be executed by processor 904. Main memory 906 also may be used for storing temporary variables or other intermediate information during execution of instructions to be executed by processor 904. Such instructions, when stored in non-transitory storage media accessible to processor 904, render computer system 900 into a special-purpose machine that is customized to perform the operations specified in the instructions.

Computer system 900 further includes a read only memory (ROM) 908 or other static storage device coupled to bus 902 for storing static information and instructions for processor 904. A storage device 910, such as a magnetic disk or optical disk, is provided and coupled to bus 902 for storing information and instructions.

Computer system 900 may be coupled via bus 902 to a display 912, such as a cathode ray tube (CRT), for displaying information to a computer user. An input device 914, including alphanumeric and other keys, is coupled to bus 902 for communicating information and command selections to processor 904. Another type of user input device is cursor control 9516, such as a mouse, a trackball, or cursor direction keys for communicating direction information and command selections to processor 904 and for controlling cursor movement on display 912. This input device typically has two degrees of freedom in two axes, a first axis (e.g., x) and a second axis (e.g., y), that allows the device to specify positions in a plane.

Computer system 900 may implement the techniques described herein using customized hard-wired logic, one or more ASICs or FPGAs, firmware and/or program logic which in combination with the computer system causes or programs computer system 900 to be a special-purpose machine. According to one embodiment, the techniques herein are performed by computer system 900 in response to processor 904 executing one or more sequences of one or more instructions contained in main memory 906. Such instructions may be read into main memory 506 from another storage medium, such as storage device 910. Execution of the sequences of instructions contained in main memory 906 causes processor 904 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 910. Volatile media includes dynamic memory, such as main memory 906. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 902. Transmission media can also take the form of acoustic or light waves, such as those generated during radio-wave and infra-red data communications.

Various forms of media may be involved in carrying one or more sequences of one or more instructions to processor 904 for execution. For example, the instructions may initially be carried on a magnetic disk or solid state drive of a remote computer. The remote computer can load the instructions into its dynamic memory and send the instructions over a telephone line using a modem. A modem local to computer system 900 can receive the data on the telephone line and use an infra-red transmitter to convert the data to an infra-red signal. An infra-red detector can receive the data carried in the infra-red signal and appropriate circuitry can place the data on bus 902. Bus 902 carries the data to main memory 906, from which processor 904 retrieves and executes the instructions. The instructions received by main memory 906 may optionally be stored on storage device 910 either before or after execution by processor 904.

Computer system 900 also includes a communication interface 918 coupled to bus 902. Communication interface 918 provides a two-way data communication coupling to a network link 920 that is connected to a local network 922. For example, communication interface 918 may be an integrated services digital network (ISDN) card, cable modem, satellite modem, or a modem to provide a data communication connection to a corresponding type of telephone line. As another example, communication interface 918 may be a local area network (LAN) card to provide a data communication connection to a compatible LAN. Wireless links may also be implemented. In any such implementation, communication interface 918 sends and receives electrical, electromagnetic or optical signals that carry digital data streams representing various types of information.

Network link 920 typically provides data communication through one or more networks to other data devices. For example, network link 920 may provide a connection through local network 922 to a host computer 924 or to data equipment operated by an Internet Service Provider (ISP) 926. ISP 926 in turn provides data communication services through the world wide packet data communication network now commonly referred to as the “Internet” 928. Local network 922 and Internet 928 both use electrical, electromagnetic or optical signals that carry digital data streams. The signals through the various networks and the signals on network link 920 and through communication interface 918, which carry the digital data to and from computer system 900, are example forms of transmission media.

Computer system 900 can send messages and receive data, including program code, through the network(s), network link 920 and communication interface 918. In the Internet example, a server 930 might transmit a requested code for an application program through Internet 928, ISP 926, local network 922 and communication interface 918.

The received code may be executed by processor 904 as it is received, and/or stored in storage device 910, or other non-volatile storage for later execution.

### Benefits of Certain Embodiments

In an embodiment, a solution as described herein improves career guidance tools available today. Current career guidance tools leverage only government data which is not up-to-date and not aligned with the needs and requirement of current employers. This solution takes a personalized approach which allows the user to either self-identify with a specific field or integrate users personal interests correlated with the most relevant matches of real-time job market information, degree programs, and the user's interests and skills to explore available programs of study. The user will be better informed to make career decisions that align with their interests and taking into account job market realities.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
storing job-interest attribute values for each job of a plurality of jobs;
wherein each job-interest attribute value corresponds to an interest;
wherein, for each job, each job-interest attribute value stored for the job indicates how much the job aligns with the corresponding interest;
obtaining user-interest information from a user;
wherein the user-interest information indicates interests of the user;
automatically selecting a set of one or more jobs, from the plurality of jobs, based at least in part on:
the user-interest information of the user; and
the job-interest attribute values associated with each job of the plurality of jobs;
presenting to the user information about each job in the set of one or more jobs, wherein the information includes at least one of
a) current market information for the job, or
b) an educational program for obtaining skills required for the job;
wherein the method is performed by one or more computing devices.

2. The method of claim 1, wherein the current market information includes at least one of
a) market demand associated with the job match,
b) salary range for the job match,
c) education requirements for the job match,
d) skills required for the job match,
e) experience required for the job match, or
f) employers associated with the job match.

3. The method of claim 2, further comprising:
filtering the top job matches using a set of filter parameters set by the user, wherein the filter parameters are based at least in part on the current market information.

4. The method of claim 1, wherein the educational program for obtaining skills required for the job includes at least one of
courses associated with skills related to the job,
degree programs associated that educational program.

5. The method of claim 1, further comprising:
filtering the plurality of jobs using a set of filter parameters, wherein the filter parameters are based at least in part on attributes associated with the plurality of jobs and filtering is performed before automatically selecting a set of one or more jobs, from the plurality of jobs.

8. A method comprising:
obtaining interest information from a user, wherein the interest information includes one or more interest attributes that reflect one or more interests of the user;
normalizing the value for each of the one or more interest attributes against the other one or more interest attributes to a length of one which represents a perfect match for the interest information;
retrieving a set of one more job matches, wherein each job match includes one or more interest attributes that reflect one or more interests associated with the job match;
determining a subset of one or more job matches from the set of one or more job matches, by calculating a distance between the values of the one or more interest attributes for the user and the values of the one or more interest attributes for each of the job matches;
returning the subset of one or more job matches.

9. The method of claim 8, further comprising:
filtering the subset of one or more job matches using a set of filter parameters, wherein the filter parameters are based at least in part on attributes associated with the job matches.

10. The method of claim 8, further comprising:
filtering the set of one more job matches, using a set of filter parameters, wherein the filter parameters are based at least in part on attributes associated with the job matches.

11. The method of claim 8, wherein the distance between the values of the one or more interest attributes for the user and the values of the one or more interest attributes for each of the job matches is calculated as the square root of the sum of the squares of the difference between the values of the one or more interest attributes for the user and the values of the one or more interest attributes for each of the job matches.

12. A method comprising:
storing job-interest attribute values for each job of a plurality of jobs;
wherein each job-interest attribute value corresponds to an interest;
wherein, for each job, each job-interest attribute value stored for the job indicates how much the job aligns with the corresponding interest;
mapping each job of the plurality of jobs to a job-specific spatial location based, at least in part, on the job-interest attribute values associated with the job;
obtaining user-interest information from a user;
wherein the user-interest information includes user-interest values;
wherein each of the user-interest values corresponds to an interest;
wherein each of the user-interest values indicates how strong the corresponding interest is for the user;
mapping the user to an interest-based spatial location based, at least in part, on the user-interest values associated with the user;
based on distances from the interest-based spatial location to the job-specific spatial locations, selecting a set of one or more jobs, from the plurality of jobs; and
presenting to the user information about each job in the set of one or more jobs.

13. The method of claim 12, further comprising:
filtering the plurality of jobs using a set of filter parameters, wherein the filter parameters are based at least in part on information about each job and the filtering is performed before selecting a set of one or more jobs, from the plurality of jobs.

14. The method of claim 12, further comprising:
filtering the set of one or more jobs, from the plurality of jobs, wherein the filter parameters are based at least in part on information about each job.

15. The method of claim 12, wherein the jobs in the set of one or more jobs presented to the user are grouped.

16. The method of claim 12, wherein distances from the interest-based spatial location to the job-specific spatial locations are calculated as the square root of the sum of the squares of the difference between the job-interest attribute values and user-interest values.
